(19) United States
(12) Patent Application Publication
(10) Pub. No.: US 2009/0101418 A1
(43) Pub. Date: Apr. 23, 2009

(54) APPARATUS AND METHODS RELATING TO VOTING SYSTEMS AND THE LIKE

(75) Inventors: Roger Thomas Young, North Yorkshire (GB); James Thomas Leavesley, Burton on Trent (GB)

Correspondence Address: GREENLEE WINNER AND SULLIVAN P C, 4875 PEARL EAST CIRCLE, SUITE 200, BOULDER, CO, 80301, US

(73) Assignee: Longhand Data Limited

(21) Appl. No.: 11/994,953

(22) PCT Filed: Jul. 11, 2006
(86) PCT No.: PCT/GB2006/002566

§ 371 Date: Jul. 18, 2008

(30) Foreign Application Priority Data
Jul. 11, 2005 (GB) 0514094.2

(51) Int. Cl. G06F 3/01

(52) U.S. Cl. 178/19.04

(57) ABSTRACT

A digital pen having a body, a sensor to provide an electronic representation of the pen's position on a writing surface, a memory to store data gathered by the sensor and a memory lock whereby unauthorised access to the data may be restricted.

### FIELD OF THE INVENTION

This invention relates, in broad terms, to the general field of voting apparatus, methods and procedures and relates more specifically, although by no means exclusively, to the application of digital paper and pen technology to these areas, and to areas similar to voting, in which form-filling/completion is required.

### BACKGROUND TO THE INVENTION AND SUMMARY OF THE PRIOR ART

The operation of a successful and fair democracy relies on the provision and running of large-scale and accountable voting processes. Historically—and in many cases even now—such votes (or “ballots”) have been conducted by way of a simple paper-based vote counting system, in which an appropriately-marked ballot paper is placed secretly into a ballot box with the total votes being counted to enable a vote winner to be identified. Generally speaking, where the scale of the election justifies it, a number of polling stations are employed at which voters may collect a ballot paper and vote in the manner described above, with it having also been possible, over more recent years, to contribute to this democratic process by using postal or proxy votes.

However, the inherent simplicity of such systems does give rise to some drawbacks, principally in terms of the time, work and organisation that is required to count the votes for the various candidates/parties, on a manual basis.

In an attempt to alleviate these difficulties, various proposals have been put forward relating to electronic voting and vote-counting procedures (known collectively as “e-voting”), with these advances dealing either with an automated way of counting standard ballot papers or by using electronic vote capturing apparatus in an attempt to computerise the polling process.

Most recently, developments have occurred in the e-voting field based on the relatively new technology of digital paper and associated pens.

A lucid summary of digital paper/pen technology can be found in Iconizer AB's International patent application WO 00/73983, from which it can be seen that the technology is based around a position-coding pattern which extends across a surface, with an appropriately-configured scanner/optical reader being used to identify, from a sub-area of the coding pattern, the region of the surface over which the scanner is passed. That, in turn, enables an electronic representation of the movement of the scanner to be obtained giving rise to an electronic representation of any words, images or characters marked on the surface by a digital pen in which the scanner is incorporated.

This technology, spearheaded by Anoto AB (see www.anoto.com) has found application in a number of areas, as illustrated, for example; in Telefonaktiebolaget LM Ericsson's International patent application WO 01/61449.

As explained in that application, specially formatted digital paper of this type, which in a preferred embodiment uses a complex algorithm-based pattern of very small dots, allows a precise location in the overall pattern to be determined, with it being possible to define a pattern having a size equivalent to 73,000,000,000,000 A4 pages—about half the size of the entire United States.

Noting that a primary requirement of an electronic voting system is the ability to perform a hand (manual) count in the event, for example, of failure of or suspected tampering with the automated apparatus and systems, WO 03/042931 (DRS Data and Research Services plc) discloses, in broad terms, the application of such digital paper/pen technology to the field of vote recording and counting. The present invention, in its various aspects, seeks to address some of the perceived shortcomings of the apparatus and methods set out in WO '931, and to provide new and useful apparatus and methods in the digital pen and paper fields.

### SUMMARY OF THE INVENTION

In accordance with a first aspect of the present invention, there is provided a digital pen having a body, a sensor to provide an electronic representation of the pen's position on a writing surface, a memory to store data gathered by the sensor and a memory lock whereby unauthorised access to the data may be restricted.

In a preferred embodiment, the pen may have a first mode of operation in which access to the memory lock is physically restricted.

The access may be restricted by an activation lock, with the memory lock desirably being engageable with a physical key. Still more preferably, the memory lock may be engageable with a mechanical key.

In the first mode of operation, engagement of the memory lock and key may be physically restricted, conveniently by a removable barrier.

The barrier may be removed by operation of the activation lock and the barrier may be physically associated with a security tether which restricts or prevents unauthorised removal of the pen from a location at which it is used.

The tether may comprise an electrical path whereby running or charging current may be supplied to the pen.

The pen may have a non-writing end, and the barrier may comprise a cap engageable with the non-writing end of the pen.

Preferably, the memory is located in a part of the pen body separated from the rest of the body by a zone of weakness. Conveniently, the memory may be located in a memory chamber spaced from the writing end of the pen.

The memory chamber, in the first mode of operation of the pen, may be at least partially covered by the cap.

Conveniently, the zone of weakness may comprise a frangible line or area which, in the first mode of operation, is disposed close to the mouth of the cap.

In accordance with a second aspect of the present invention, there is provided a digital pen having a body and a memory chamber disposed within the body; the memory chamber being separated from the rest of the body by a zone of weakness such that an unauthorised attempt to access the chamber can result in the chamber becoming detached from the rest of said body.

The pen, in use, may be securely tethered to an anchor to restrict or prevent unauthorised removal of the pen from a location at which it is used, the tether being attached to or integral with the pen such that breakage of the pen at the zone of weakness does not allow the chamber to break free of the tether.

The digital pen of the second aspect of this invention may additionally comprise any one of the features of the invention in its first aspect.

In accordance with a third aspect of the present invention, there is provided use of the digital pen of either of the first two aspects of the present inventions in the casting and/or recording of votes.

In accordance with a fourth aspect of the present invention, there is provided an electronic vote recording system comprising a plurality of digital pens in accordance with the first or second aspects.

In accordance with a fifth aspect of the present invention, there is provided a ballot paper for use in a voting process comprising a region in which a mark may physically be made to signify a voting choice, the ballot paper being produced using digital paper whereby an appropriately-configured digital pen may obtain an electronic representation of the vote cast, the ballot paper having an identifier readable by the pen whereby a link may be established between the vote and the ballot paper on which it was cast.

A set of such ballot papers may be provided, each paper having a unique identifier whereby links may be made between multiple votes and the ballot papers on which they were cast.

In accordance with a sixth aspect of the present invention, there is provided a set of digital paper sheets bearing identical or substantially identical digital paper patterns, the sheets of the set being distinguishable from each other by way of differently-coloured, differently-shaded or differently-hued patterns being provided on different sheets of the set.

In accordance with a seventh aspect of the present invention, there is provided a digital pen having a colour-sensitive sensor such that the pen may be operable only to record data from one or more of a plurality of colours of a given digital paper pattern.

The sensor may be adjustable so that the pen can be switched so as to be receptive to different colours of a given pattern.

Preferably, the pen may have an interchangeable colour filter whereby the desired colour sensitivity can be achieved.

In accordance with an eighth aspect of the present invention, there is provided, in combination, a colour-sensitive digital pen and a plurality of sheets of digital paper, the sheets bearing identical or substantially identical digital paper patterns but with at least some of the patterns being provided in a different colour, shade or hue to the rest.

In accordance with a ninth aspect of the present invention, there is provided a method of recording a vote cast using a ballot paper having a region in which a mark may be made to signify a voting choice, the method comprising electronically detecting the position of a digital pen, relative to the paper, as the mark is made, so as to provide an electronic representation of the vote cast, and electronically detecting an identifier of the ballot paper to establish a link between the vote and the ballot paper on which it was cast.

The method may use a plurality of ballot papers each having a unique identifier whereby links may be established between multiple votes and the ballot papers on which they were cast.

The ballot paper or papers may be produced using digital paper with the digital paper pattern being used to provide both the representation of the vote or votes and the identity of the ballot paper/papers on which the vote/votes was/were cast.

In accordance with a tenth aspect of the present invention, there is provided, in combination, a digital pen having a body and a sensor to provide an electronic representation of the pen's position on a writing surface, and a memory to store data gathered by the sensor, the memory being disposed within a housing remote from the pen body and connected to the body by a security tether.

The tether may comprise a data path whereby data gathered by the sensor may be passed to the memory.

The tether may comprise an electrical path whereby running or charging current may be passed from the housing to the pen.

The tether may be releasably connected to the housing.

The tether may be connected to the housing by an activation lock.

The housing may be a tamper resistant, strengthened or armoured box.

The activation lock may be operative to activate and deactivate the pen.

The housing may have a zone of weakness such that an unauthorised attempt to access the memory can result in the pen and/or tether becoming detached from the housing.

The housing may contain a plurality of memories, each associated with a different digital pen, such that data from a plurality of different pens may be stored at a common location.

In accordance with an eleventh aspect of the present invention, there is provided a digital pen having a body, a sensor to provide an electronic representation of the pen's position on a writing surface, a local or remote processing element to process data gathered by the sensor and a feedback element whereby visual, tactile or sonic information may be passed to the user, in response to the data processing.

The processing element may be attached to or integral with the pen's body.

The processing element may be in data communication with, but physically spaced from, the body.

The processing element may be operative to process the data in conjunction with information relating to the writing surface, such that the feedback passed to the user may be contextualised.

### BRIEF DESCRIPTION OF THE DRAWINGS

Specific and strictly non-limiting embodiments of the invention will now be described, by way of example only, by reference to the accompanying drawings, of which:

FIG. 1 shows a schematic cut-away illustration of a digital pen;

FIG. 1.1 illustrates a sample key for use with the pen of FIG. 1;

FIG. 2 shows an example of a Ballot Station Pen Register used in the implementation of the voting systems described;

FIG. 3 represents a sample Digital Ballot Paper;

FIG. 4 is illustrative of an uncertain vote;

FIG. 5 shows a proforma ballot paper of the type which could be used by a “roaming” voter as described below;

FIG. 6 shows a schematic cut-away illustration of an alternative form of digital pen, having a remote memory; and

FIG. 7 shows a schematic cut-away illustration of a still further embodiment of a digital pen, having a feedback element.

### DETAILED DESCRIPTION OF THE DRAWINGS AND BEST MODE OF THE INVENTION

As explained in the opening paragraphs set out above, the proposal underlying the present invention is to introduce computer technology to known and long-established ballot and similar form-filling processes by facilitating the electronic collection of votes using digital paper and pens during the voting process. As will immediately be appreciated, the incorporation of such technology allows the retention of the long-established and favoured method of casting a vote using pen and paper; although the availability of such a cast vote in digital format allows computer software, hardware and firmware to provide the following operations and advantages:
vote counting and election-turnout validation;
vote sorting into good, bad, and doubtful categories using voting rules applied by appropriate software;
ready management of complex proportional representation election systems;
ready management of joint elections (e.g. general/national elections combined with local/European elections on a given ballot day);
the display of ballot paper images on computer screens to allow returning officers to adjudicate on doubtful ballot papers and voter intentions; and
storage of election results and rapid reporting of such results.

Overall, the intention underlying this proposal is to reduce election count times, administration and thus election costs. In the UK alone a typical national general election costs just over £50,000,000 with it being clear, in the case of emergent democracies, that such sums are far from trivial. In addition, as will be seen from what follows, the various aspects of the invention permit public voting to occur at a wide variety of locations which adds flexibility and advantages to the relatively restricted polling station options which are currently available. In addition, certain facets of the invention simplify the voting process from a voter's perspective.

The technology underlying these proposals is explained simply by the terms “digital paper” and “digital pens”. A key player in this field is the Swedish company Anoto AB (see www.anoto.com), with the Anoto digital pattern comprising, in summary, an arrangement of very small dots printed in a near-grid arrangement with the indices of the grid being spaced 0.3 mm apart. The pattern is offset from a true grid layout by an amount for each dot which is defined by a complex algorithm. Over the whole sheet of any one given pattern, the arrangement of dots is different, with different pages thus being defined by a different algorithm. For convenience, it should be noted that the algorithm for a particular page is known as a “page address”.

Some form-filling applications of digital paper technology are also known, comprising the combination of human-readable text and boxes which make up a conventional check-list or application form. The present invention expands on this and extends such form-filling technologies into a new area—that of ballot papers. Thus, on a digital ballot paper to which the present invention relates, the “form” will typically be provided by a list of candidates, with boxes/regions for voters to annotate with their choice of party or candidate. As will be appreciated, whatever style of form is used, these may be printed at the same time as the digital paper pattern or subsequently, onto “plain” patterned digital paper.

The complementary aspect of the basic Anoto technology is a digital pen which, in essence, has dual functionality. On the one hand, the pen is able to operate conventionally, placing a physical (ink) mark on a paper or other such substrate, but with the pen also being equipped with appropriate scanner/optical reader apparatus and software which recognises the digital paper pattern over which the pen is passed, such as when the conventional mark is made. Thus, in general terms, known (prior art) digital pens, available from such companies as Logitech and Nokia, comprise a conventional ink cartridge, a camera or other such optical pick-up which faces down towards the nib of the pen, a solid-state memory chip containing appropriate firmware to provide operating instructions to the pen's circuitry, a battery, a memory to store data gathered via the pick-up and an output device or facility whereby the gathered data can be transferred to a separate data processing device for manipulation or display, for example.

Expanding on the proposals set out in WO '931, the applicants have come up with a number of novel and inventive developments and improvements using digital paper and pen technology, which can usefully be summarised as follows:
modified digital pens inventively adapted to meet technical, security and legislative requirements relating to election and other form-filling processes;
improved digital ballot papers having unique identities, meaning that each digital ballot paper will be different, removing the need to identify them with any overprinting such as a barcode or number;
coloured digital paper patterns, to increase the scale and usefulness of available patterns. In brief, by printing the same pattern on different sheets, but by using different ink colours, shades or hues and colour-specific cameras, a given digital pattern can readily and securely be used more than once. Similarly, it is envisaged that different coloured patterns can be used on a given paper sheet so as to be selectively readable by different, appropriately-configured pens;
a multiple election facility using a single digital ballot paper, thus avoiding the need to cast different votes on separate papers;
increasing tiers of sophistication to the voting process are envisaged, with an aim being to increase voter turnout and reduce election costs. For example, a first level implementation might see digital paper voting introduced to existing, non-web connected and entirely local polling station voting processes, which would require hardly any change to voter registration and poll station management processes, in addition to not demanding any substantial additional cost. Subsequently, as digital connections are introduced by governments and local authorities, polling stations are likely to become web-enabled allowing greater degrees of sophistication such as “roaming voting”, whereby a registered voter is able to vote away from his/her local polling station at any publicly accessible place that governments might choose to allow.

### Overview of the Digital Paper Voting Process

However implemented, and whichever level of available/possible sophistication is adopted, the digital ballot paper voting process of the present invention involves digital paper ballots which are completed by voters using a digital pen, which, as outlined above, results in a “standard” mark being made on the ballot paper. The digital ballot papers are then placed in a ballot box, in the normal way, which are then transported to a central location for the votes to be counted. However, at this stage, the process deviates from the standard procedure, in that instead of counting ballot papers manually, the count managers will download electronic representations of votes, stored in the pens' memories, or in memories associated with/connected to/in communication with the pens.

It will immediately be understood, however, that the system is flexible such that ‘ordinary’ votes—i.e. votes not cast on digital paper, such as standard postal or proxy votes, for example—can also be counted (manually or perhaps electronically, by way of appropriate scanners) and thus contribute to the overall result. In other words, whilst in a preferred embodiment the whole election process will be conducted using digital paper marking and counting technology, this is by no means necessary, with this flexibility being potentially attractive where there is reluctance (perhaps at government level) to introduce a new electoral system ‘at one fell swoop’.

In order to implement the novel and inventive aspects described herein, the applicants propose, in a preferred embodiment, that at least two different types of digital pen be used during the vote casting, recording and counting processes. First, a “voting pen” is envisaged for use in polling booths by voters, to record their votes. Second, a “ballot manager pen” is envisaged being used to administer the various polling station processes, with the two pens being readily distinguishable, perhaps by virtue of being different sizes, colours or shapes. As explained hereafter, however, these two “main” types of pen may themselves have different configurations and constructions, and thus different “versions” of each are envisaged.

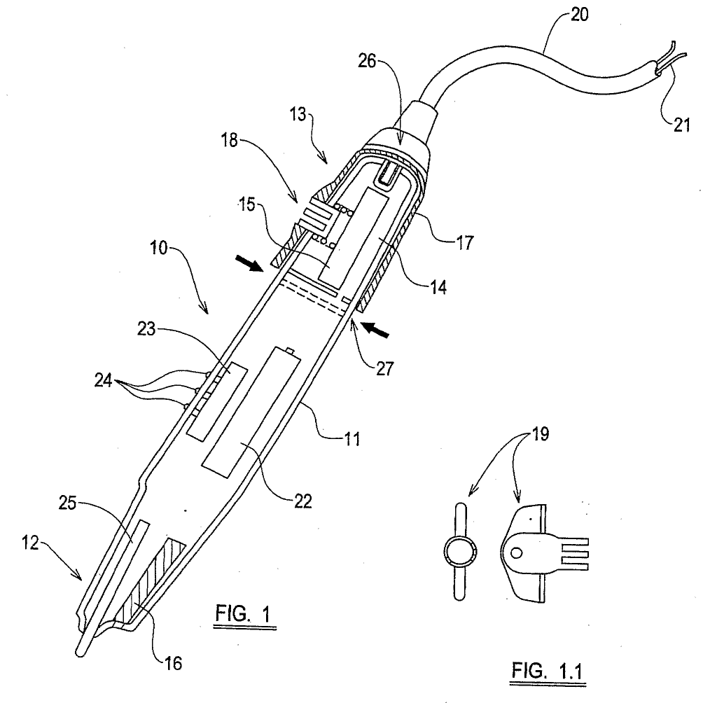

A schematic illustration of one type of “voting pen” is shown at 10 in FIG. 1, with the pen having a body 11 defining a writing end 12, a non-writing end 13 and a memory chamber 14 disposed towards the non-writing end 13. The pen's memory card 15, which stores data gathered by way of an optical sensor/pick-up 16, is protected, in the memory chamber 14, by a cap 17, secured in place and to the pen by an activation lock 18, operable using a key such as a polling key of the type exemplified by the key 19 shown in FIG. 1.1. As can be seen from FIG. 1, the cap 17 is integral with a secure tether (known as a lanyard) 20 which attaches the pen to a polling booth, in a secure (substantially irremovable) manner. As shown at 21, trickle charge cables run through the tether sheath for the purpose of supplying charging current to a battery 22, although it will be appreciated that the cable 21 could also or alternatively supply “running” current to the pen, in the event of a battery malfunction or loss.

Other elements of the pen 10, such as an electronic control unit 23, status lights 24, and a conventional ball point ink cartridge 25 are generally standard in the field of digital pen design with it thus not being necessary to expand on those particular aspects, here.

A further non-standard element of the pen, however, is a memory lock 26 which, during normal use of the pen, is concealed by the cap 17.

The memory lock 26 is configured so as to be operable using a second (and different) key, perhaps also of the general type shown at 19, known as a “count key”.

The activation lock 18, as explained briefly above, is operable using a “polling key” which is supplied to polling station managers, and whose function is to unlock pens from the tether caps 17 (so as to allow later data download) and also to activate the pen for voting use. On the other hand, the principal function of the count key is to allow count managers to download data from the memory card 15, with the data being representative of the votes cast using the pen.

As will be appreciated, physical security of the pen is an important factor in the field of election processes, as it is conceivable that attempts could be made to alter an election result by stealing or interfering with voting pens. In an attempt to prevent this, the secure tether 20 provides a first line of defence in that it ties the pen to the polling booth. It is appreciated that the booth may need to be reinforced, with the applicants suggesting that a long metal bar or scaffold pole threaded across several polling booths might be appropriate, to make it impossible or highly impractical for the bar/pole (and thus the booths) to be removed from the polling station.

As a second line of defence, the cap 17, conveniently made from a toughened plastics material, is designed to protect the memory card if an attempt is made to separate a pen from its tether. Realising that most types of pen will eventually break if sufficient force is applied, the applicants have come up with a third line of defence, in the form of a zone of weakness 27 disposed between the writing and non-writing ends of the pen. The effect of the zone of weakness 27 (in a preferred embodiment, a frangible line or reduced thickness portion) is that it will snap just below the tether cap 17, with the memory card 15, being disposed within the memory chamber 14, not being released from the tether (and thus the polling booth) in the event of such a forceful attack. To allow data already stored in the memory card 15 to be utilised, the applicants envisage that a simple (and generally conventional) memory card reader could be provided to returning officers, for the purpose of reading data from stand-alone memory cards.

As explained above, the activation lock 18 is operable using a polling key 19, with release of the lock allowing the pen to be freed from the tether, at the end of polling, so that it may be taken to the count for subsequent vote data download.

It should be noted, in connection with both the memory and activation locks, that physical (key-operated) locks are only preferred, with the applicants envisaging that software/biometric/PIN access controls or other forms of “lock” could equally well be utilised. To that end, the applicants envisage that biometric sensors (such as fingerprint recognition devices) could be used to allow polling staff, returning officers and the like to enable/disable the various pens used in the overall voting process. As such access control devices are known in themselves (but not in connection with digital pens), it is not thought necessary or appropriate to elaborate on those, here.

As outlined above, in addition to the “polling pens”, a second type of pen—“poll clerk” pens—are also envisaged as being used, by poll managers or clerks, to capture ballot paper numbers as the ballot papers are issued to voters. This process is explained in more detail below, with the design of the pen being largely similar to that of the ballot pens, but lacking the tether and tether cap, as the issues of vote casting security do not present themselves in the capture of ballot paper numbers.

Acknowledging the security issues described above, the applicants also envisage alternative forms of pens (e.g. voting and poll clerk pens) in which no, or a limited capacity, memory facility is provided. In such an embodiment, data gathered by the pens' sensors will be conveyed to a memory or data store remote from the pens, for later access and use by (for example) the counting apparatus and processes. It will be appreciated that this ‘removal’ of the pens' vote-storage (or other data storage) memories provides an effective security level in that it is not possible for any pen tampering or theft to lead to any vote or data loss. As an additional security measure, the remote data stores could be ‘stand-alone’ in that they are not web-enabled or connected to any network beyond (for example) the polling station.

Noting some issues on the integrity of wireless transmissions, the applicants propose that a data cable, wire or other such physical conduit could be used to connect the pens and remote data store, with the conduit conveniently being provided by an appropriate part of the tether described above. It should be understood, however, that the use of wireless transmission protocols is also clearly envisaged, with infra-red, radio frequency or ‘Bluetooth’ systems being the most technically viable.

Thus, in alternative embodiments of the pen 10, the memory chamber 14 and associated memory card 15 may be omitted, with those elements being provided in a physically secure “memory box” at a location remote from the pen 10 itself. In that arrangement, the tether may carry a data cable as well as the trickle charge cable 21, to transfer data from the optical sensor/pick-up 16 to the remote memory box. The battery 22 may also be omitted, with power being supplied remotely, conveniently by way of the cable 21. This simplifies the pen's construction and design, with the memory (e.g. a chip or card) being disposed away from the pen's body, giving increased data security. The memory may be contained within a remote armoured box, with it being envisaged that data from multiple pens could be stored within a single box. Thus, a “common” remote box could conceivably contain a plurality of memory cards/chips, with a lock being used to attach/detach the pens' tethers to the box. As will be understood, the effect of this is that the activation lock 18 is moved away from the pen's body, to a remote position, on or near the box, with multiple memories being stored at a common location. This reduces the overall system cost and increases flexibility. Thus, in this alternative embodiment, the activation lock is used to secure the tether(s) to the memory box, and/or to activate/deactivate the pen(s), perhaps by way of a 2-step sequence [e.g. turn key part-way to secure tether to remote memory box; turn key fully to activate the pen]. Of course, there may also be a lock on the pen body itself, to allow it to be attached/detached from the tether, perhaps for maintenance/servicing/cleaning purposes.

In the “remote memory” embodiment, the zone of weakness may be provided near or adjacent the remote memory card/chip, such that forced removal of the pen results either in the pen alone being released, or the pen and tether—not the memory.

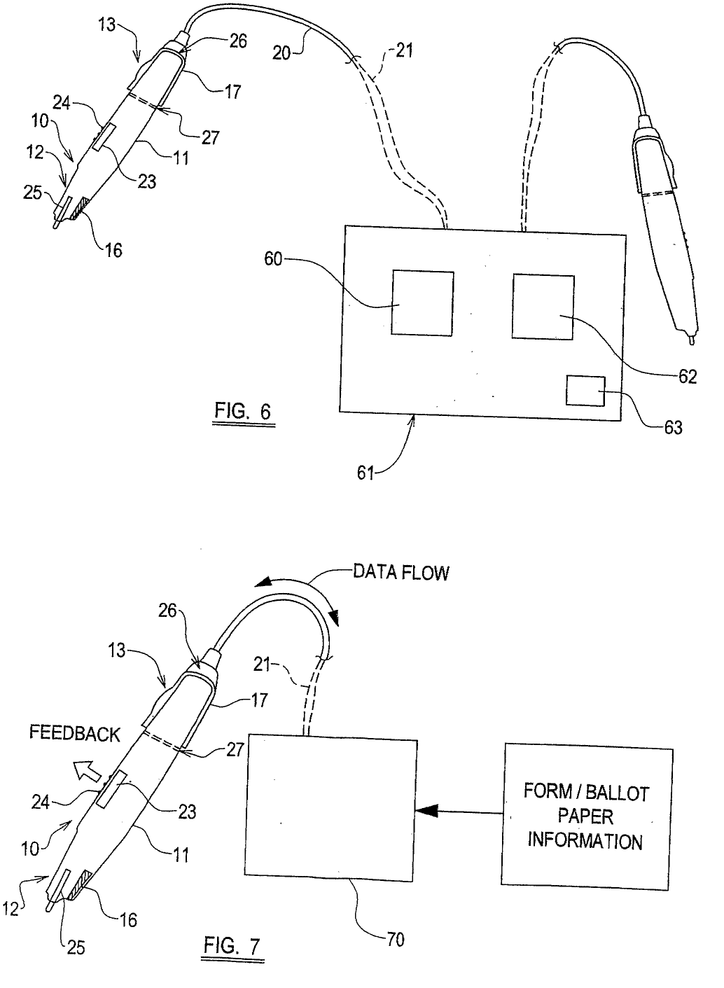

A schematic illustration of such a type of pen is shown in FIG. 6, in which the reference numerals of FIG. 1 have been used to signify like parts. Thus, the pen again has a body 11 defining a writing end 12, a non-writing end 13 and an optical sensor/pick-up 16. The pen has a cap 17, secured to the pen body. As can be seen from FIG. 6, the cap 17 is integral with a secure tether (or lanyard) 20 which attaches the pen to a remote memory housing, in, a secure (substantially irremovable) manner. As shown at 21, electrical cables run through the tether sheath for the purpose of supplying “running” current to the pen, which avoids the need for an internal battery, which reduces weight and cost. The embodiment shown in FIG. 6 also differs from that shown in FIG. 1 in that no memory chamber or card is provided as part of the pen, with the memory 60 (for storage of data gathered by the pen) instead being contained within the remote memory housing 61. As shown, the housing 61 can contain several memories for storing data gathered by multiple pens, with memory 62 being associated with the other pen shown. Of course, more than two pens can be associated with a common memory housing.

Activation of the pens can be effected by use of an activation lock 63, which can take the form of a physical (key-operated) lock, or a software implemented (i.e. electronic) lock. As mentioned above, the activation lock can also be used to attach/detach the pens' tethers to/from the housing, although the tethers could of course also be secured to/released from the housing by other means.

This alternative form of pen in which no memory facility is provided allows data gathered by the pens' sensors to be conveyed to the remote memory housing, via the tether, for later access and use by the counting apparatus and processes. It will be appreciated that this ‘removal’ of the pens' memories provides an additional security level in that it is not possible for any pen tampering or theft to lead to any vote or data loss.

The pen 10 may further comprise elements for providing feedback to a user, for example coloured indicator lights, light emitting diodes (LEDs) to generate readable text, vibration generators or voice synthesised responses. These may give a simple indication that the user has completed an action, for example the pen may vibrate or a light may flash if a vote has successfully been cast. However, the applicants envisage that more sophisticated feedback could readily be provided. For example, using Intelligent Character Recognition (ICR), as described elsewhere in this specification, the pen could indicate to a user that they have voted for a particular candidate, and request confirmation of the vote. In this way, the system can provide feedback to the user, which is used in turn to provide further information to the system. This feedback, whilst ideally delivered to the user via the pen itself, could be generated by way of a connection to a remote network, or perhaps by internal circuitry and instructions contained with the remote memory box described above. Whichever way it is implemented, it will be understood that the feedback can be contextualised (i.e. provided in a context), in that the information passed back to the user is generated in the light of (and with knowledge of) the nature of the form, ballot paper or the like which has been written on. This allows “form-specific” feedback to be provided, which can be of assistance to inexperienced or naïve users of the pen, for example.

This is illustrated schematically in FIG. 7. As shown, this contextualised feedback can be passed to the user by way of the status lights 24, for example, with information regarding the vote cast/mark made on the paper being processed by a processing element 70, which (in this example) is remote from the pen. It could, of course, be contained within the pen body. Information relating to the ballot paper/form itself is supplied to the processing element so that the marks made on the paper can be put into context. As will be appreciated, the information relating to the ballot paper/form can be stored and accessed locally, or remotely, perhaps via a network connection.

### Typical Polling Day Operation and Processes

Before a polling station opens, the ballot manager/poll clerk will check all pens which are to be used at that polling station, with the process involving attaching pens to tethers (or attaching the tethers to a remote memory box) using polling keys and the activation locks described above. The various pens will likely be distributed from a central point under the control of election officers, with their associated memory cards (local or remote) having been blanked prior to arrival at the polling station. As an additional check, it is envisaged that the ballot manager/poll clerk will record which particular pens are used in a polling station, using a pen check list.

To that end, each of the pens will be marked with a unique serial ID number. On the assumption that a particular pen is operating satisfactorily, a green status light 24 (see FIG. 1) will shine when it is switched on and connected to the tether cap using the poll key and activation lock. At that point, the poll clerk will be aware that the battery is charged, that the pen is securely attached to the tether cap and is receiving a trickle charge, and that the pen is ready to accept votes.

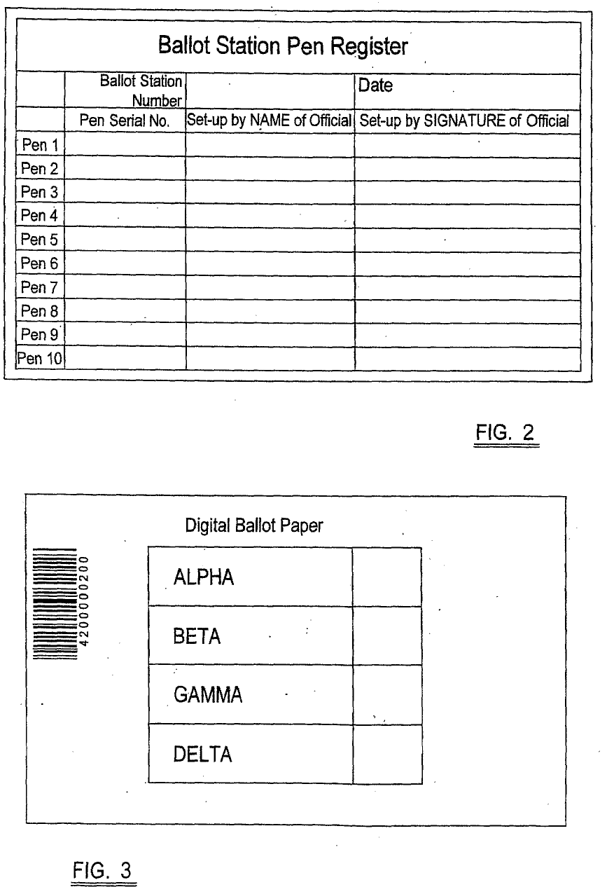

The first task of the pens, once activated, will be for the ballot manager/poll clerks to record the serial numbers of the pens used at their ballot station on a Ballot Station Pen Register, as shown by example at FIG. 2. This Register is printed on non-unique digital paper, with the function of the exercise being to record to the pen which polling station it is in and which officer set it up and switched it on. The data input in this way is recorded by the pen and stored in the pen's memory (or on the remote memory, if the card is not disposed within the pen), for subsequent downloading into appropriate digital paper tally software, at the count. The sum of entries for all pens used at a polling station provides data sufficient to calculate turn-out, as will be understood.

In order to limit the possibilities of election tampering or fraudulent activity, the digital voting software at the count, which receives the pens' voting data, will be configured to accept only legitimate digital ballot papers. With that in mind, if a voter should mischievously take into a polling station another sheet of digital paper (for example from a simple digital notebook purchased in a stationery shop) and writes on it using one of the voting pens, whilst the paper sheet itself will likely be accepted (i.e. introduced into the ballot box) it will not confuse the electronic vote, since the page address of the “rogue” ballot paper will not be recognised by the digital paper counting software and will thus be discarded.

In order to increase the scope and flexibility of the digital paper process, a further refinement is proposed by the applicants in which the digital paper pattern used on the ballot papers is printed in another colour/shade/hue than is available for other, non-ballot digital paper products. To be able to read other colours it will be understood that a digital pen will need to have an appropriately configured camera/pick-up which is able to accept different wavelengths of light. In addition, if the pens' scanners are filtered so as to accept only one colour/shade/hue then ballot papers, or indeed any digital paper form, could be printed with more than one coloured pattern. In this way, a particular filtered pen—for example one which reads only a red pattern—could be used to gather information from defined areas on a form which are printed with the correct colour of pattern.

In this specific field—that of digital paper voting—coloured patterns could thus be used to ensure that no data is collected from any other digital paper, by using dedicated digital ballot papers which are printed in a colour which is specific to the filters used in the voting pens at a particular election. Where subsequent elections are conducted, a different colour could be used, thus ensuring that “old” ballot papers could not be used with fraudulent intent.

As will be appreciated, the use of coloured digital paper patterns is also effective to increase the use of the otherwise unique paper patterns supplied by paper suppliers such as Anoto. As elections may well use up to 100,000,000 sheets, a given pattern could be re-used if printed for other elections or constituencies, in a different colour, shade or hue.

### The Voting Process

In accordance with the various aspects of this invention, the first stage of the process is voter registration. When a voter arrives at a polling station their identity will be checked, in the normal way, with their name then being crossed off the register of names. The poll clerk digital pen may be used to do this, with there perhaps being a “digital paper” coding adjacent each voter's details, to allow an electronic record of each voter to be obtained. As normal, the ballot manager/poll clerk will mark the ballot paper with an official stamp.

The poll clerk digital pen, distinguishable from the voting pens by colour, for example, is then used to swipe (i.e. “read”) any part of the digital ballot paper before it is handed to a voter to take to the polling booth. The function of this second pen is to capture, for each polling station, the number and page address of all ballot papers used in that particular polling station. This number/page address capture provides the count software with identifying information concerning the ballot papers used, in addition to the total number of separate ballot papers given out, which can be used in a turn-out calculation. As will be appreciated, capture of the ballot papers' individual identifiers is possible because each digital ballot paper will be provided with a unique identifying pattern of optically-readable markings.

For elections which follow the British system there are a number of voter security requirements that operate at the point of vote casting: in the polling station, just before being handed to a voter, ballot papers must be marked with an official stamp, to identify them as genuine.

In addition, as will be appreciated, ballot papers are sequentially numbered, with the serial number appearing on both the ballot paper and the counterfoil from which it is torn. In existing poll procedures a poll clerk will write the voter's registration number on the counterfoil, so that, if necessary, (and only by court order) it is possible to track a particular vote (if fraud is alleged) via the ballot number to its counterfoil partner and thus via the voter registration number back to the name of the voter concerned. The use of digital papers and pens in the novel and inventive processes described herein does not necessarily detract from this requirement, with it being envisaged that the ballot papers will continue to be numbered in this way. An example of such a numbered ballot paper is shown at FIG. 3.

However, the unique page address feature of the ballot papers used in the applicants' proposal provides a novel and inventive solution to requirement of ballot paper numbering, where regulatory changes so permit. As described above, the digital paper pattern on a page (exemplified by the Anoto pattern) is derived from an algorithm which is represented on a digital paper by a number which is reflected in the pattern. Anoto, for example, provide a version in which the algorithm and hence the pattern is unique for each page, with a particular ballot paper's pattern thus being effective to identify that specific paper to the count system.

Thus, in adopting a unique pattern for each ballot paper it becomes possible to use the page address as a unique identifier—the ballot paper number. This could be displayed as the number only, but the applicants' current preference is to print it as a barcode and number, displayed on the counterfoil only. Digital voting pens will capture the unique ballot paper number when it reads the pattern during the vote casting process.

As there is a legal requirement (at least in the United Kingdom) that completed ballot papers should be trackable back to the voter, the present invention allows a particular ballot paper to be matched to its original counterfoil, by using a non-voting digital pen to make a mark on suspicious ballot papers. If necessary this could be done without ink—i.e. using a digital pen simply as a reader of the digital paper pattern. From this reading the digital pen will be able to query a central database of page addresses and display the actual page address being referenced. If desired, this process could be carried out off-line with no requirement to make use of any web connectivity. Thus it will be appreciated, either way, that from this step it is then easy to locate the counterfoil concerned (because the page reference is written on it) and that the voter registration number, written on the counterfoil, can then be used to identify the actual voter.

Whilst the basic paper-to-pen data capture process embodied in digital paper/pen technology is well known, the applicants envisage that Intelligent Character Recognition (ICR) could additionally be used in order to interpret the various marks made on ballot papers, to perform a check step regarding allowable/unallowable/questionable ballots. It will thus readily be understood that a number of voting “rules” using ICR can be set up, whereby images gathered via the voting pens can be compared to recognised lexicons, such as the 26 character alphabet, the 10 integer lexicon and perhaps a list of names, symbols or other such markings.

In the voting field, the applicants' system uses a lexicon defined for the particular election marks allowed on a ballot slip for that election. The list used will include the marks defined for ballots under guidance rules produced for circulation by returning officers, with these rules also interpreting how in existing ballots staff at the count set aside (for adjudication by the returning officer) those ballot papers which are deemed invalid.

It is thus envisaged that the use of voting lexicons will be in two stages:

### Automatic Adjudication Using ICR

Existing rules for invalidating a ballot paper are
a) if it does not bear the official mark
b) votes are given to more than one political party/candidate
c) anything is written or marked on the ballot paper by which the voter can be identified (except the printed number of the ballot paper)
d) it is unmarked or void for uncertainty (i.e. it is not clear for which political party or candidate the voter intended to vote)

Using ICR and an appropriate voting lexicon it will be possible to set aside as void digital ballot papers that fall into categories b) and c) above. For invalidation category d) above the voting lexicon will select out and invalidate (i.e. remove from counting) any unmarked votes.

### On Screen Adjudication of Votes Deemed Invalid

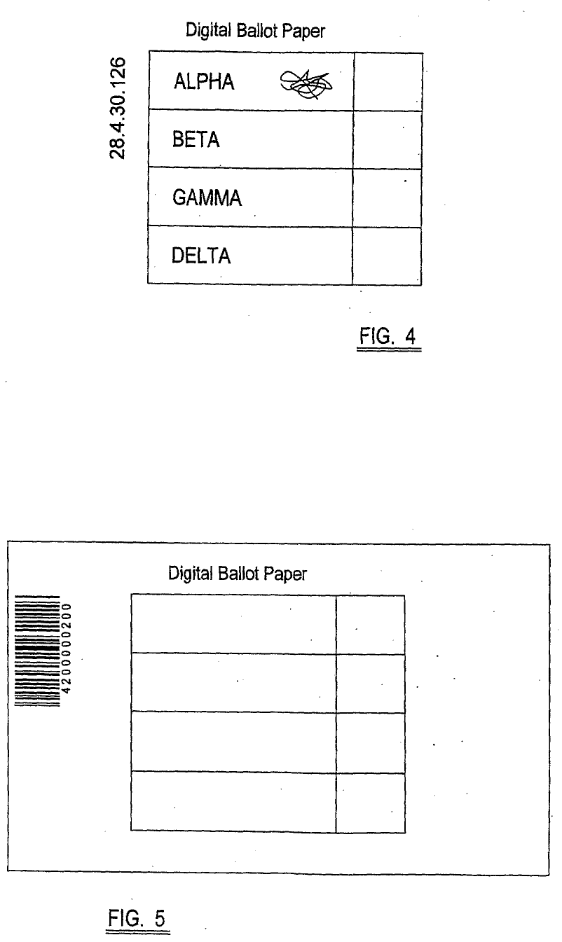

In the case of an uncertain vote (where, for example, there is a single mark in the right place but which is not of a type recognised by the voting lexicon), these votes will be set aside for adjudication by the returning officer). An example of such an uncertain vote is shown in FIG. 4, in which there is no mark in the active areas (the four boxes forming the right hand column) but in which there is a mark of some form adjacent to candidate “ALPHA”. Adjudication by the returning officer and staff can decide the validity of this vote by viewing the ballot on screen—the ballot paper used is identifiable by recognition of the paper's unique page address and the marking made is recorded, by the voting pen, in generally conventional manner. A composite image can then be prepared in which the vote marking is overlaid onto the ballot paper image, to allow a decision to be made as to the validity of the vote, without it being necessary to retrieve the ballot paper concerned from the ballot box.

It will be appreciated, in addition, that the automated vote recordal/counting processes described herein also provide a valuable opportunity for other voting systems to be accommodated. For example, proportional representation (PR), in which a transferable vote process counts first, second, third (and so on) choices uses mathematical concepts well suited to automated calculations. Thus, a suitable lexicon could be used (ICR looking for numbers/digits) with a PR tally routine then performing the necessary calculations. For example, if the version of PR had a three-choices rule, the tally routine would identify (via the ICR lexicon) all the one's, and add them, all the two's and so on.

### Voting Logic: Summary of Active-Area Processes

Active areas are the regions on the right on the sample votes illustrated in FIGS. 3 and 4. Voting logic operates as a two-step process:

Step One: is there writing only within one active area? If yes, then the vote is passed to step two. If however more than one box has been marked, or if there are additional marks elsewhere on the ballot paper, the vote is deemed doubtful and filed separately (see File 2 below). This step does not discriminate between types of mark—it simply recognises that there is a mark and that it is in a valid place.

Step Two: assuming a vote passes the first logic step a subsequent test will compare the mark correctly placed against the voting lexicons used in that election, for any one of a variety of marks to be accepted as a good vote as defined for the ballot.

Active area logic can be as varied as the voting rules applied. Votes are processed by voting logic into one of two files:

File 1: Invalid Votes—where the defined voting rule has been clearly transgressed e.g. more than one candidate voted for; or no mark made or handwriting added.

File 2: Doubtful Ballot—papers that fail Step One but where adjudication is needed to confirm validity or, if discernible, for the returning officer to attribute the vote to one candidate or another, such as that shown in FIG. 4.

The voting rules can be adapted to weight how a vote is filtered—for example all votes failing primary rules could be filtered to file 2 for returning officer adjudication. On the other hand all votes which have only one mark, in the right place but not in the voting lexicon could be accepted as a valid vote and not be set aside into either file 1 or 2.

### The Wider Election Process

### Alternative Ways of Using Digital Paper in Elections

The descriptions above cover the core voting processes: how digital paper is used to capture a mark on a ballot paper, extract meaning using ICR software, filter the result according to voting rules and either count a vote if valid or provide an image of it if doubtful, for adjudication. That is the core functionality around which a variety of additional options can be added. A description of additional variations is described below.

### Roaming Voting

This augmentation will be possible, in the UK, when the implementation takes place for the full introduction of CORE: the Co-ordinated On-line Register of Electors (see www.odpm.gov.uk). This database will be managed at government level (via the Department of Constitutional Affairs, in the UK) and will be an online database showing all eligible voters. It will be understood, however, that the “CORE” references herein are purely exemplary and that the process is applicable generally, where a central voter database is set up.

### Registering for a Roaming Vote

The proposal adds to the list of existing methods already available to voters:
at local polling stations
postal voting

Roaming voters will vote on a proforma digital ballot-paper, a stock of which is carried by the mobile voting station. FIG. 5 shows such example of such a paper. They have pattern and a blank voting form but no candidate names. The proforma will have as many boxes with ICR active areas as the largest constituency requires.

Registering at an appropriate time before the election, voters get eligibility to have a roaming vote—registering their choice much as they do when asking for a proxy vote or a postal vote. Details will be recorded on CORE, or on any equivalent database of voters. The proposal is to make roaming polling available at a variety of places:
post-offices
banks
railway station concourses
mobile polling stations set up in vans and trucks
embassies
military bases and stations.

### Casting a Roaming Vote

On entering a mobile ballot station voters will show to the ballot manager/polling clerk whatever means of identification the CORE process defines for access to the database. Once a voter's ID is confirmed—and CORE indicates that the voter has previously registered to vote in this way—the voter will be given a digital ballot paper generated from a proforma digital ballot paper over-printed with the candidates' names appropriate to the voter's constituency.

Capturing the Ballot Number from Proforma Digital Ballot Papers

Using a barcode reader or digital pen the polling clerk will scan the ballot paper barcode or pattern and record this number against the name of the voter on CORE. This number is also passed to the digital ballot paper software to tie that ballot paper to the relevant constituency.

### Voting

After casting their vote using a digital voting pen the voter will place the voting paper into a ballot box—which will be labelled and coloured (or otherwise configured) differently to identify it as a roaming ballot box. After polls close roaming ballot boxes will be taken to regional centres and held against the eventuality that a hand count at any constituency will require their presence. Alternatively they could be opened at once and ballot papers sorted into constituency lots; this is a variable open for ballot managers and returning officers to decide.

### Attempts at Fraud

If a person registers to vote locally, or by post, and does so and then attempts a roaming vote as well, the system will be robust against this fraud because the voter's name will not be flagged on CORE as having rights of a roaming vote. The person will be turned away from the mobile ballot station.

On the other hand, if a voter registers as a roaming voter, uses that option and then attempts to vote at home, in their local polling station, the system will again be robust against this attempt because at the local polling station the printed register supplied to the poll clerk will have a letter marked against the voter's name indicating that that person has registered as a roaming voter. This process is an extension of the system already used to indicate proxy or postal voters. The person will be turned away and directed to a roaming polling booth. If the local polling station is Internet connected—and has access to CORE—it may be possible (as decided at an earlier election planning stage) for roaming voters to be eligible to cast their vote at local polling stations. The process will be for the voter's name to be crossed off the register of names AND flagged on CORE so that no further vote is possible at a mobile polling station.

### Close of Ballot Processes at Conventional Non-Roaming Polling Stations

When the poll closes the ballot manager/poll clerk prepares the end of poll official forms as per normal election processes:
completes the Ballot Paper Account, declaration by companion to blind voters, List of Blind Voters and so forth
In addition a secure box will be provided for the ballot manager's digital pen and the digital voting pens, or for the pens' memories, if remote from the pens' bodies.

### The Count

On arrival at the count, ballot boxes will not be opened. Instead they will be put securely to one side and the pens downloaded (i.e. data from the memory cards is extracted) under the supervision of the returning officer.

Downloading Data from the Polling Pens

This is achieved by placing the voting pens into multiple-block cradles—cradles able to take many pens at one time, perhaps in groups of 10, though any reasonable volume is possible. Blocks will be attached to a computer network operating the digital paper voting software used to tally results. To download a pen a count clerk inserts a count key in the end of the pen. This slot was previously covered by the tether cap when the pen was active at a polling station.

The count key 24 triggers a pen to download. Once downloaded a different coloured light will shine on the pen indicating it is empty.

Downloading creates two sets of data: one of votes to be processed through the voting logic tally software, the other the entry on the Ballot Station Pen Register for that pen.

If remote memories are used, then the download process is similar, although it will probably not be necessary to use pen cradles—memory card readers would likely suffice.

### Verification

This is the process count managers use to determine the total votes actually cast and is used to determine the turn-out. It requires all ballot papers to be counted, but not sorted. This total number is compared to the number of ballot papers issued by polling clerks in polling stations. Counting the number of ballot papers issued is not enough—voters sometimes take ballot papers away after voting and do not place them in ballot boxes. For any one polling station this calculation will be carried out automatically in a digital paper ballot. To do so the software will draw on data collected by voting digital pens and poll clerk digital pens, from their internal or remote memories:

a) total number of ballot papers issued: this data comes from the recorded total of ballot papers issued as recorded by the poll clerk pen, as explained above.
b) total number of votes: this data is supplied by the voting pens' “memories”. As many pens/memories from different polling stations will be downloaded at one time at the count it is important to be able to tie the votes from any one polling station together—the validation step. This is possible because when set up at the start of polling each pen will have been used on the Ballot Station Register (see FIG. 2). The record of this entry from the pen will link the voting data from that pen to the polling station where it was used.
c) turn-out: is calculated in different ways in different elections. However all systems use a combination of a) and b) above combined with the total number of registered voters (from CORE when that system is active).

### Joint Constituencies

It is often the case that two elections will be carried out at the same time; for example a general election and a local council election. Hitherto, voters have used different ballot papers which are either placed in different ballot boxes, or quite often, put together into a single box. In this latter case the two types of ballot papers have to be sorted and separated at the count. A further complexity is common in which at this first opening the mixed ballot papers are sorted, one election count is carried out at that location, whilst the ballot papers for the second election are put back into the ballot box and taken to another count. Digital paper voting will accommodate this requirement by configuring the software used by the pens to download votes when the count key is turned but not to delete the votes.

The tally software will know the difference between data for one election and that of another because to do so is an extension of the logic already used to define the votes for one candidate compared to another.

After the pens/their memories have downloaded for a first time they will be taken to the count for the second election and downloaded a second time. Here the logic will reverse and the tally software will ignore votes from the first election.

### Counts by Hand

For all tally and adjudication processes, however simple or complex there will be a fall-back position in which the original paper is hand-counted in the manner of previous times. When or if this option is exercised is a matter of procedure to be agreed in principle before an election and carried out using agreed rules as and when necessary. However when no problem occurs, either on a technical level, or because of the closeness of the result it is envisaged by the applicants, that it should be possible with this proposal to call a result for an election in less than an hour. Limitations of timeliness will relate only to the number of download blocks used and the number of doubtful votes that may count in a close election and have to be adjudicated on.

Indeed, for the vast majority of elections, there will be no need to count manually any ballot papers.

It will be appreciated by those skilled in the art that, whilst the present invention has been described principally in relation to voting systems, it can equally find application in other situations where form-filling is required, for example in financial transactions at banks, building societies and post offices, police notebook completion, in filling in forms such as passport applications or applications for other documents such as driving licences and the like, in schools, government and commercial buildings and for completing lottery tickets. The user feedback facility described above is likely to be especially important in such latter areas, as the level of users' abilities and experience with such pens will vary considerably.

When used in this specification and claims, the terms “comprises”, “comprising” and “having” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A digital pen having a body, a sensor to provide an electronic representation of the pen's position on a writing surface, a memory to store data gathered by the sensor and a memory lock whereby unauthorised access to the data may be restricted.

2. A digital pen according to claim 1, wherein the pen has a first mode of operation in which access to the memory lock is physically restricted.

3. A digital pen according to claim 2 wherein said access is restricted by an activation lock.

4. A digital pen according to any one of claims 1 to 3 wherein the memory lock is engageable with a physical key.

5. A digital pen according to claim 4 wherein the memory lock is engageable with a mechanical key.

6. A digital pen according to any one of claims 2 to 5 wherein, in the first mode of operation, engagement of the memory lock and key is physically restricted.

7. A digital pen according to claim 6 wherein the engagement is restricted by a removable barrier.

8. A digital pen according to claim 7 wherein the barrier can be removed by operation of the activation lock.

9. A digital pen according to claim 7 or claim 8 wherein the barrier is physically associated with a security tether to restrict or prevent unauthorised removal of the pen from a location at which is it used.

10. A digital pen according to claim 9 wherein the tether comprises an electrical path whereby running or charging current may be supplied to the pen.

11. A digital pen according to any one of claims 7 to 10 wherein the barrier comprises a cap engageable with a non-writing end of the pen.

12. A digital pen according to any one of the preceding claims wherein the memory is located in a part of the pen body separated from the rest of the body by a zone of weakness.

13. A digital pen according to any one of the preceding claims wherein the memory is located in a memory chamber spaced from the writing end of the pen.

14. A digital pen according to claim 13 wherein the memory chamber, in the first mode of operation of the pen, is at least partially covered by the cap.

15. A digital pen according to any one of claims 12 to 14 wherein the zone of weakness comprises a frangible line or area which, in the first mode of operation, is disposed close to the mouth of the cap.

16. A digital pen having a body and a memory chamber disposed within the body, the memory chamber being separated from the rest of the body by a zone of weakness such that an unauthorised attempt to access the chamber can result in the chamber becoming detached from the rest of said body.

17. A digital pen according to claim 16 wherein the pen, in use, is securely tethered to an anchor to restrict or prevent unauthorised removal of the pen from a location at which it is used, the tether being attached to or integral with the pen such that breakage of the pen at the zone of weakness does not allow the chamber to break free of the tether.

18. A digital pen according to claim 16 or claim 17 having the additional features set out in any one of claims 1 to 15.

19. Use of the digital pen of any one of claims 1 to 18 in the casting and/or recording of votes.

20. An electronic vote recording system comprising a plurality of digital pens as claimed in any one of claims 1 to 18.

21. A ballot paper for use in a voting process comprising a region in which a mark may physically be made to signify a voting choice, the ballot paper being produced using digital paper whereby an appropriately-configured digital pen may obtain an electronic representation of the vote cast, the ballot paper having an identifier readable by the pen whereby a link may be established between the vote and the ballot paper on which it was cast.

22. A set of the ballot papers of claim 21, each paper having a unique identifier whereby links may be made between multiple votes and the ballot papers on which they were cast.

23. A set of digital paper sheets bearing identical or substantially identical digital paper patterns, the sheets of the set being distinguishable from each other by way of differently-coloured, differently-shaded or differently-hued patterns being provided on different sheets of the set.

24. A digital pen having a colour-sensitive sensor such that the pen may be operable only to record data from one or more of a plurality of colours of a given digital paper pattern.

25. A digital pen according to claim 24 wherein the sensor is adjustable so that the pen can be switched so as to be receptive to different colours of a given pattern.

26. A digital pen according to claim 24 or claim 25 wherein the pen has an interchangeable colour filter whereby the desired colour sensitivity can be achieved.

27. In combination, a colour-sensitive digital pen and a plurality of sheets of digital paper, the sheets bearing identical or substantially identical digital paper patterns but with at least some of the patterns being provided in a different colour, shade or hue to the rest.

28. A method of recording a vote cast using a ballot paper having a region in which a mark may be made to signify a voting choice, the method comprising electronically detecting the position of a digital pen, relative to the paper, as the mark is made, so as to provide an electronic representation of the vote cast, and electronically detecting an identifier of the ballot paper to establish a link between the vote and the ballot paper on which it was cast.

29. A method according to claim 28 using a plurality of ballot papers each having a unique identifier whereby links may be established between multiple votes and the ballot papers on which they were cast.

30. A method according to claim 28 or claim 29 wherein the ballot paper or papers is/are produced using digital paper and wherein the digital paper pattern is used to provide both the representation of the vote(s) and the identity of the ballot paper(s) on which it (they) was (were) cast.

31-37. (canceled)

38. In combination, a digital pen having a body and a sensor to provide an electronic representation of the pen's position on a writing surface, and a memory to store data gathered by the sensor, the memory being disposed within a housing remote from the pen body and connected to the body by a security tether.

39. The combination of claim 38 wherein the tether comprises a data path whereby data gathered by the sensor may be passed to the memory.

40. The combination of claim 38 or claim 39 wherein the tether comprises an electrical path whereby running or charging current may be passed from the housing to the pen.

41. The combination of claim 38, claim 39 or claim 40 wherein the tether is releasably connected to the housing.

42. The combination of claim 41 wherein the tether is connected to the housing by an activation lock.

43. The combination of any one of claims 38 to 42 wherein the housing is a tamper resistant, strengthened or armoured box.

44. The combination of claim 43 wherein the activation lock is operative to activate and deactivate the pen.

45. The combination of any one of claims 38 to 44 wherein the housing has a zone of weakness such that an unauthorised attempt to access the memory can result in the pen and/or tether becoming detached from the housing.

46. The combination of any one of claims 38 to 45 wherein the housing contains a plurality of memories, each associated with a different digital pen, such that data from a plurality of different pens may be stored at a common location.

47. (canceled)

48. A digital pen having a body, a sensor to provide an electronic representation of the pen's position on a writing surface, a local or remote processing element to process data gathered by the sensor and a feedback element whereby visual, tactile or sonic information may be passed to the user, in response to the data processing.

49. A digital pen according to claim 48 wherein the processing element is attached to or integral with the pen's body.

50. A digital pen according to claim 48 wherein the processing element is in data communication with, but is physically spaced from, the body.

51. A digital pen according to claim 48, claim 49 or claim 50 wherein the processing element is operative to process the data in conjunction with information relating to the writing surface, such that the feedback passed to the user may be contextualised.

52. (canceled)
